(19) United States
(12) Patent Application Publication
(10) Pub. No.: US 2007/0101880 A1
(43) Pub. Date: May 10, 2007

(54) Printing line with a web storage unit and post-processing system

(76) Inventors: Manfred Wiedemer, Ismaning (DE); Otto Ferber, Germering (DE)

Correspondence Address: SCHIFF HARDIN, LLP;PATENT DEPARTMENT, 6600 SEARS TOWER, CHICAGO, IL, 60606-6473, US

(21) Appl. No.: 10/559,028

(22) PCT Filed: Jun. 9, 2004
(86) PCT No.: PCT/EP04/06253

§ 371 Date: Nov. 21, 2006

(30) Foreign Application Priority Data
Jun. 10, 2003 (DE) 103 26 080.3

(51) Int. Cl. B41F 13/54

(52) U.S. Cl. 101/228

(57) ABSTRACT

In a method for operating a printing line comprising a first printer that prints print images on a continuous first web, and at least one second printer that prints print images on a continuous second web, the webs are post-processed with at least one post-processing system. With a web storage unit, the webs printed by at least one of the printers are buffered, the web storage unit being arranged between the printers and the post-processing system. With the post-processing system, the at least one printed web stored in the web storage unit has access.

### BACKGROUND

The preferred embodiment concerns a printing line with a first printer that prints print images on a continuous first web, at least one second printer that prints print images on a continuous second web, and with at least one post-processing system which post-processes the printed webs. The preferred embodiment also concerns a method for operation of a printing line.

In addition to a printing system, conventional printing lines comprise a complex post-processing system that cuts, folds and sorts the printed paper (in the form of a continuous web), binds it into books or brochures and/or franks it. For economic reasons, the apparatuses and mechanisms belonging to the post-processing system are connected in series and operation in the same time as the upstream printing system. A cycle shortening and a simplified operation of the post-processing system is thus achieved. In practice, different process speeds result for the mechanisms of the post-processing system and for the printer or printers, such that a mismatch results given the serial passage of the printing material. Downtimes of individual components of the overall system can also lead to a material jam occurring in the pass operation.

Given the coupling of mechanisms of post-processing systems with modern digital printers, it is frequently determined that the capacities are not attuned to one another. Mechanisms or apparatuses of a post-processing system are typically designed for process speeds greater than 4 to 5 m/sec, while the digital printers with high print quality typically have a process speed of 1 to 2 m/sec. Due to this mismatching in terms of the process speeds, the cycle speed that can be achieved with conventional post-processing systems cannot be fully utilized. Higher process speeds with digital printers can be achieved in principle; however, an over-proportionally high technical effort is required for this, for example in the associated preparation of the digital data. On the other hand, due to the necessary stable mechanical design and the high degree of automation of the components, the achievement of the cited high process speed with relatively little technical effort is possible in the apparatuses of the post-processing system. A reduction of the capacity of these apparatuses would thus hardly be economically advantageous.

A printing system with at least three printing devices as well as a method for operation of such a printing system is known from U.S. Pat. No. 6,381,440 by the same applicant (parallel European patent application EP-A-1 202 134). A first printer prints the front side of a paper web. The back side of this paper web is printed in a second printer and this back side is printed with a further color overcoat in a third printer. It is possible to arrange this printing line comprised of three printers twice, such that the entire printing system then comprises six printers, whereby a high capacity is achieved. Nevertheless, given connection to a post-processing system a significant mismatching can occur in terms of the process speed.

A printing system and printing method for generation of a color mixed sheet sequence is described from U.S. Pat. No. 6,363,231 by the same applicant (parallel PCT patent application WO 99/09459). The entire system for printing of single sheets comprises a digital printer operating with a high speed, which digital printing generates monochrome print images or print images with two colors. A digital color printer is also provided that is coupled with the aforementioned printer via a paper path coupling module. A superordinate control unit allocates the single sheets to be printed to the printing groups, which single sheets are collected in a common sheet collection direction in order to then be transported further to a post-processing system. A high-capacity printing with more than 70 pages per minute can be achieved with the aid of this printing system with a plurality of printers.

A device for buffering of web-shaped material is known from WO 97/35797. The device comprises a rotatably borne, hollow outer coil body processing system accesses the at least one printed web stored in the web storage unit.

### BRIEF DESCRIPTION OF THE DRAWINGS

FIG. 1 shows a printing line with two printing systems and a loop storage as a web storage unit;

FIG. 2 shows a printing line in which the web storage unit comprises two cage storages;

FIG. 3 shows a printing line in which the web storage unit comprises three roller units;

FIG. 4 shows a printing line with five identical roller units; and

FIG. 5 shows a printing line in which the web storage unit comprises three roller units that have a common bearing shaft.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

According to the preferred embodiment, the printer (which prints a continuous web) is not directly coupled with the post-processing system; rather, the continuous web is initially conveyed into a web storage unit and buffered there. In this manner it is possible to arrange a plurality of printers that feed the webs printed by them to the web storage unit. The volume of printed material then present in the web storage unit is relatively high and can be output to the post-processing system with an increased speed relative to the printing speed of an individual printer. This increased output speed is Due to the decoupling of the digitally-operating printer from the components of the post-processing system, the one or the other component of the printing line can be exchanged during the overall service life without reducing the efficiency of the overall printing line. For example, further-developed individual components can thus be incorporated into the overall printing line in a simple manner.

A further advantage arises due to the fact that printers and apparatuses of the post-processing are differently prone to interference. Due to a decoupled production in the printing line, the availability of individual components does not necessarily limit the capacity of the entire printing line. For example, the repair times or other downtimes can also be bypassed without performance loss or loss of efficiency.

A further advantage results in that, given a failure of a printer, a printing reserve is still present due to the decoupling of the printer from the post-processing system. The overall printing line can thus then produce further with reduced capacity given failure of a printer.

Another advantage results in that a reserve can be produced due to a longer operating duration of a printer or of a plurality of printers. This reserve can be buffered in the web storage unit and be further processed by the post-processing system at a later point in time. Given digitally-operating printers, it cannot always be guaranteed that the available data can be printed without further measures. For example, the fonts required in the print job can not be available or a specific color is required in the print job that is not immediately available in the current printer. An operating personnel must then in fact take corresponding measures, for example select a different font or download the correct font via software; furthermore, he can exchange the color station or select another color. These measures are typically always connected with production interruptions. When a plurality of printers are now present or a corresponding reserve of printed paper has been produced in reserve, this time in which this reserve is further-processed by the post-processing system can thus be used to execute such measures without the overall productivity of the printing line suffering from them.

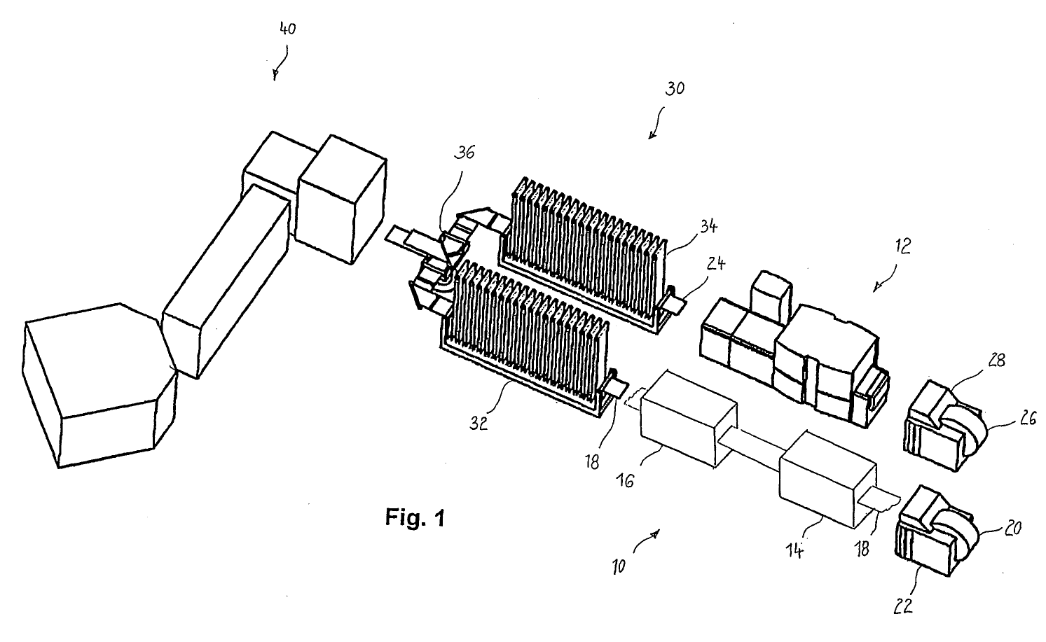

FIG. 1 shows a printing line that contains two printing systems 10, 12. The first printing system 10 is executed as a tandem system and comprises two printers 14, 16 that either print two color separations on the same side of the continuous web 18 in the operating mode “spot color printing” or print the front side and back side of the continuous web 18 in the operating mode “duplex printing”. The continuous web 18 is unrolled from a roll 20 that is borne in a roller unit 22.

The other printing system 12 is designed as a digital duplex printing system and prints on both sides a continuous web 24 that is unrolled from a roll 26 and is supplied to the printing system 12 via the roller unit 28. The printed continuous webs 18, 24 are supplied to a unit generally designated as a web storage unit 30. This web storage unit 30 comprises a first loop storage 32 and a second loop storage 34. Each of the loop storages 32, 34 (which are known in the field of paper processing) comprises a plurality of rollers between which the continuous web material input is stored in a meandering manner. The loop storages 32, 34 operate as FIFO storages (first-in first-out) and supply the respective continuous web 18, 24 to a cross table 36 from which the selected web 18 or 24 is specifically transported further to a post-processing system 40. This post-processing system 40 can comprise components such as a cutting system, a folding system, a sorting system, a bookbinding system and/or a franking system.

In the arrangement shown in FIG. 1, the printed matter in the form of the continuous web 18 or the continuous web 24 can selectively be supplied from one of the loop storages 32 or 34 to the post-processing system via the cross table 36 while printed web material can furthermore be conveyed into the respective other loop storage.

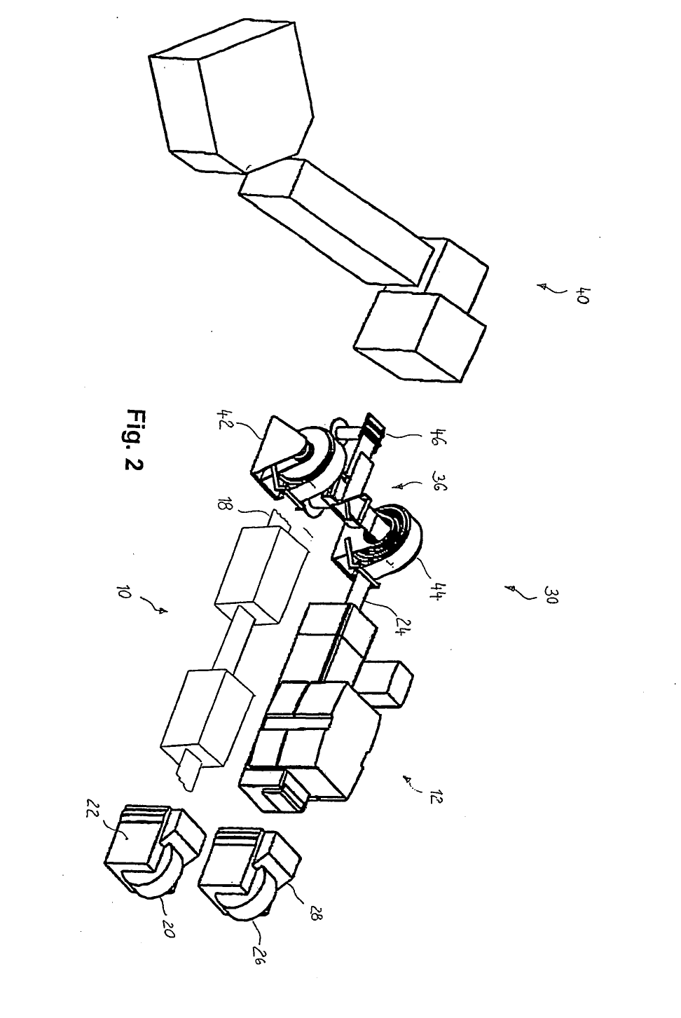

FIG. 2 shows a further example of an arrangement of a printing line, whereby identical parts are designated identically. Here the web storage unit 30 comprises two cage storages 42, 44 that operate as FIFO storages. Each cage storage 42, 44 stores the continuous web 18 or 24 supplied to it and outputs the respective continuous web 18, 24 via a cross table 36. The design of the cage storages 42, 44 is described in the aforementioned WO 97/35797 by the same applicant. This document is incorporated by reference into the disclosure of the present patent application.

An adhesion unit 46 with whose help the end of a printed continuous web 18, 24 connected with the beginning of the subsequently printed continuous web 18, 24 is downstream from the cross table 36.

The printed matter can be conveyed from one of the two cage storages 42, 44 to the post-processing system 40 via the cross table 36, during which printed material is buffered in the respective other storage.

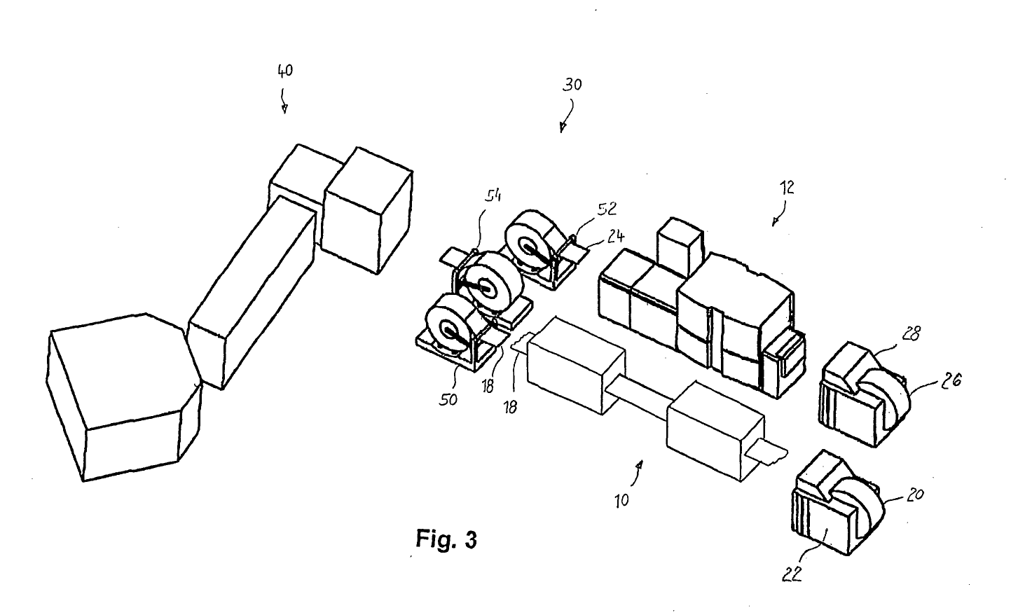

FIG. 3 shows a further arrangement in which the web storage unit 30 comprises one roller unit 50, 52 per printer 10, 12. The continuous web 18 or 24 is wound into rolls on these roller units 50, 52. Furthermore, an additional roller unit 54 is provided that is arranged in the reverse direction and serves to unroll an already-printed continuous web from the roll. The roller units 50, 52, 54 are similarly designed and equipped with a sub-surface drive that comprises cylinders arranged below on which the rolls rest, which rolls are driven by these cylinders given winding and unwinding. The roller units 50, 52, 54 align with regard to the roller axis, such that a simple change of the roll from the roller units 50 and 52 to the roller unit 54 is possible. For this the corresponding roll is axially shifted from the roller unit 50 or 52 into the roller unit 54 while one of the printers 10,12 further prints the other continuous web, and is wound by one of the roller units 50 or 52. The roll change can thus occur both manually and automatically. An interruption-free printing operation of the post-processing operation is possible with the aid of the illustrated arrangement.

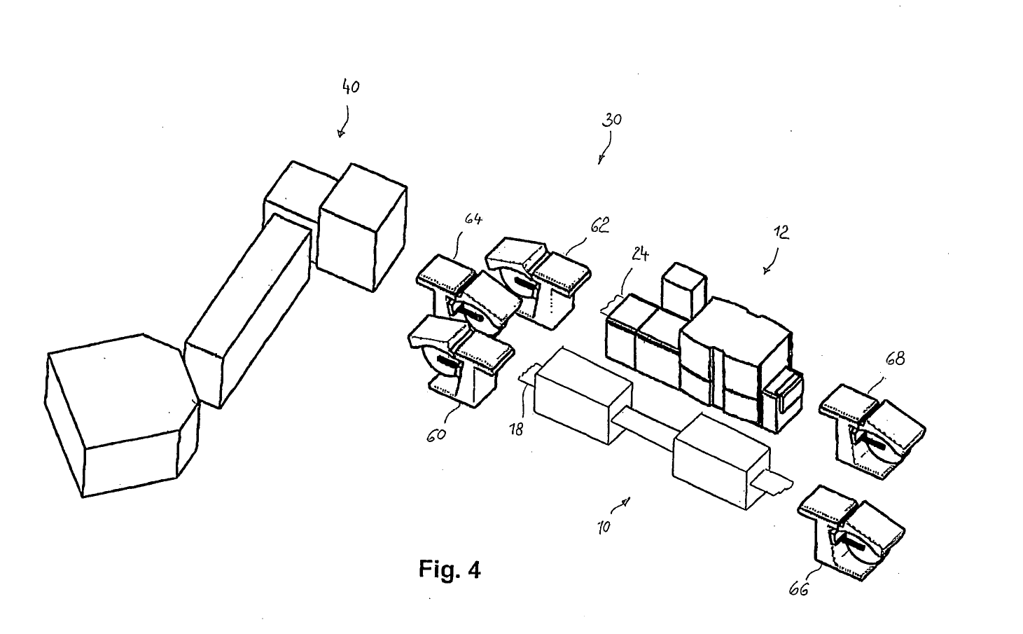

FIG. 4 shows a further variant of a printing line in which the web storage unit 30 likewise comprises three roller units 60, 62 and 64. The middle roller unit 64 operates in the unwinding direction while the roller units 60, 62 operate in the winding direction. The roller units 60, 62, 64 are similar to the roller units 66, 68 that feed the continuous webs 18, 24 to the printing systems 10, 12, whereby an increased efficiency is provided. The roller units 60 through 68 are equipped with a surface drive, whereby a simple roll change from the roller units 60, 62 to the roller unit 64 for unwinding is possible. The respective roll is only axially shifted into the roller unit 64 for the post-processing while the non-participating roller unit 60, 62 furthermore winds printed material that is printed by the active printing system 10 or 12. The respective other printing system is briefly stopped given the roll change.

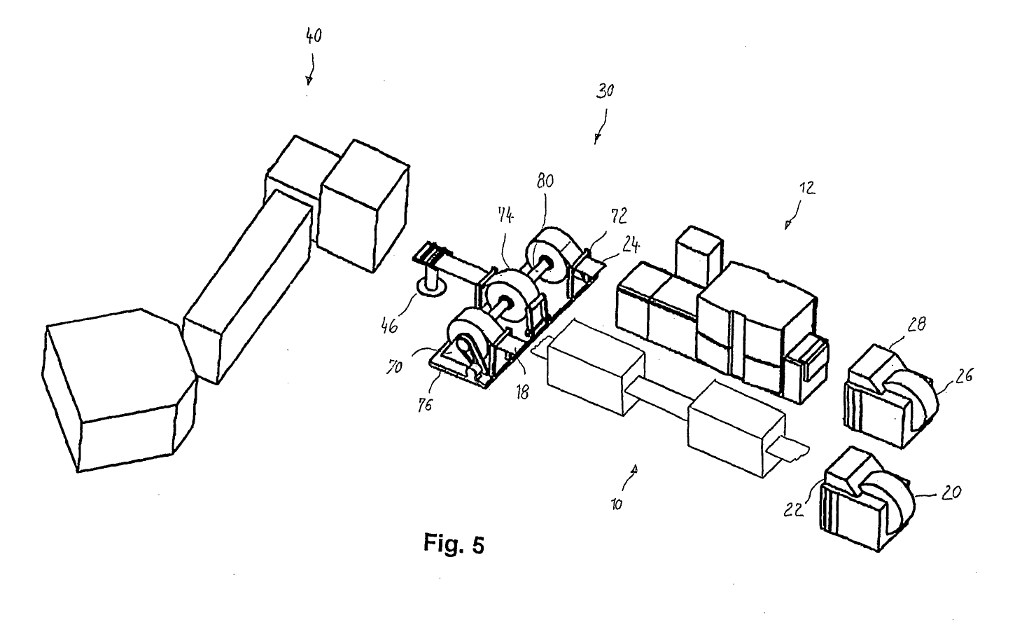

FIG. 5 shows a further exemplary embodiment of the printing line. Per printing system 10, 12 the web storage unit 30 comprises one roller unit 70, 72 for winding up the continuous webs 18, 24. An additional roller unit 74 serves for unwinding of full rolls. The roller units 70, 72, 74 have a common base frame 76 and a common bearing shaft 80 on which the respective rolls can be wound and unwound. The rolls are borne such that they can be shifted in the axial direction on the bearing shaft 80, whereby a shifting from the winding position to the unwinding position can be easily realized. This roll change can occur both manually and automatically. The outer roller units 70, 72 possess a central drive, a sub-surface drive or a surface drive for winding the rolls. The middle roller unit 74 advantageously possesses a surface drive or a sub-surface drive.

An electrical control unit (not shown) is provided to control the printing line according to the exemplary embodiments of FIGS. 1 through 5. During the printing with the printing systems 10, 12, the print pages are counted so that the print pages are known before the adhesive joining and after the adhesive joining into bound webs. This information is forwarded to the post-processing system 40 in order to insert the required blank pages there. Print products such as books, catalogs can be produced nearly without spoilage in this manner with the shown printing lines.

The shown exemplary embodiments can be modified in many cases. Instead of the shown printing systems 10, 12, the printers cited in the aforementioned documents U.S. Pat. No. 6,381,440 or U.S. Pat. No. 6,363,231 can also be used. More than two printing systems can also be provided, whereby the storage elements in the web storage unit 30 are to be correspondingly adapted.

A further web storage in which a section of a printed continuous web is buffered can be provided before the post-processing system 40 in the processing direction. The post-processing system 40 can be supplied with web material from this web storage while a gluing process occurs, for example in a gluing station 46.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-36. (canceled)

37. A printing line, comprising:
a first printer that prints print images on a continuous first web;
at least one second printer that prints print images on a continuous second web;
at least one post-processing system which post-processes the webs;
a web storage unit that buffers the webs printed by the printers and which is arranged between the printers and the post-processing system; and
the post-processing system accessing a printed web stored in the web storage unit.

38. A printing line according to claim 37 in which the web storage unit comprises at least two loop storages that respectively store a continuous printed web, at least one of the loop storages being connected with the post-processing system.

39. A printing line according to claim 39, in which the at least two loop storages are connected on an output side via a cross table that supplies a selected continuous web to the post-processing system.

40. A printing line according to claim 37 in which the web storage unit for each printer comprises a cage storage that buffers a respective continuous printed web.

41. A printing line according to claim 40 in which two cage storages are connected on an output side with a cross table from which a selected web is transported from one of the two cage storages to the post-processing system.

42. A printing line according to claim 37 in which the web storage unit comprises one roller unit per printer, said roller unit winding the printed continuous web onto a roll, whereby an additional roller unit is provided that outputs a finished, wound, printed web to the post-processing system.

43. A printing line according to claim 42 in which the roller units are similarly designed and respectively have a sub-surface drive, whereby the rolls are aligned axially relative to one another on the roller units.

44. A printing line according to claim 43 in which the rollers are borne on the roller units such that they can be shifted in an axial direction.

45. A printing line according to claim 37 in which a roller unit that supplies an unprinted continuous web to the respective printer is arranged upstream from each printer.

46. A printing line according to any of the claims 45 in which the roller units upstream from the printers and roller units downstream from the printers have a same design.

47. A printing line according to claim 42 in which the roller units are equipped with a surface drive.

48. A printing line according to claim 37 in which the web storage unit comprises one roller unit per printer as well as one additional roller unit, the roller units have a common bearing shaft on which the rolls can be wound and unwound, and whereby the rolls on the bearing shaft are borne such that they are shiftable.

49. A printing line according to claim 48 in which, given three roller units, both of outer roller units respectively wind a printed continuous web and a middle roller unit unwinds a printed continuous web.

50. A printing line according to claim 48 in which the roller units have a central drive, a sub-surface drive or a surface drive.

51. A printing line according to claim 37 in which an adhesion unit is provided that connects an end of one printed continuous web with a beginning of a printed web to be unwound from the web storage unit.

52. A printing line according to claim 37 in which a further web storage is provided before the post-processing system in which for further web storage a segment of a printed continuous web is stored, and with the further web storage the post-processing system is supplied with web material while a gluing process occurs in which ends of printed continuous webs are connected.

53. A printing line according to claim 37 in which a simplex printer or a duplex printer is used as at least one of the first and second printers.

54. A printing line according to claim 37 in which the post-processing system comprises a cutting system, a folding system, a sorting system, a bookbinding system or a franking system.

55. A method for operating a printing line that comprises a first printer that prints print images on a continuous first web, and at least one second printer that prints print images on a continuous second web, comprising the steps of:
post-processing the webs with at least one post-processing system;
with a web storage unit, buffering the webs printed by the printers, the web storage unit being arranged between the printers and the post-processing system; and
with the post-processing system, accessing a printed web stored in the web storage unit.

56. A method according to claim 55 in which the web storage unit comprises at least two loop storages that respectively store a continuous printed web, whereby at least one of the loop storages is connected with the post-processing system.

57. A method according to claim 56 in which the at least two loop storages are connected on an output side via a cross table that supplies a selected continuous web to the post-processing system.

58. A method according to claim 55 in which the web storage unit for each printer comprises a cage storage that buffers the respective continuous printed web.

59. A method according to claim 58 in which two cage storages are connected on an output side with a cross table from which a selected web is transported from one of the two cage storages to the post-processing system.

60. A method according to claim 55 in which the web storage unit comprises one roller unit per printer, the roller unit winding the printed continuous web onto a roll, whereby an additional roller unit is provided that outputs a finished, wound, printed web to the post-processing system.

61. A method according to claim 60 in which the roller units are similarly designed and respectively have a sub-surface drive, whereby the rolls on the roller units are aligned axially relative to one another.

62. A method according to claim 61 in which the rollers are borne on the roller units such that they are shiftable in an axial direction.

63. A method according to claim 55 in which a roller unit that supplies an unprinted continuous web to the respective printer is arranged upstream from each printer.

64. A method according to claim 60 in which roller units upstream from the printers and roller units downstream from the printers have a same design.

65. A method according to claim 60 in which the roller units are equipped with a surface drive.

66. A method according to claim 55 in which the web storage unit comprises one roller unit per printer as well as one additional roller unit, the roller units have a common bearing shaft on which rolls can be wound and unwound, and the rolls on the bearing shaft being borne such that they can be shifted.

67. A method according to claim 66 in which given three roller units, both of outer roller units respectively wind a printed continuous web and a middle roller unit unwinds a printed continuous web.

68. A method according to claim 66 in which the roller units have a central drive, a sub-surface drive or a surface drive.

69. A method according to claim 55 in which an adhesion unit is provided that connects an end of one printed continuous web with a beginning of a printed web to be unwound from the web storage unit.

70. A method according to claim 55 in which a further web storage is provided before the post-processing system in the further web storage a segment of a printed continuous web being stored, and from the further web storage the post-processing system is supplied with web material while a gluing process occurs in which ends of printed continuous webs are connected.

71. A method according to claim 55 in which a simplex printer or a duplex printer is used as a printer.

72. A method according to claim 55 in which the post processing system comprises a cutting system, a folding system, a sorting system, a bookbinding system or a franking system.

73. A method for operating a printing line that comprises a first printer that prints print images on a continuous first web, and at least one second printer that prints print images on a continuous second web, comprising the steps of:
post-processing the webs with at least one post-processing system;
with at least one web storage unit, buffering at least one of the webs, the at least one web storage unit being arranged between the printers and the post-processing system; and
with the post-processing system, accessing the at least one printed web stored in the at least one web storage unit.
